(19) United States
(12) Patent Application Publication
(10) Pub. No.: US 2015/0293382 A1
(43) Pub. Date: Oct. 15, 2015

(54) Method and System for Virtual Try-On and Measurement

(71) Applicant: Pro Fit Optix, Inc., Irving, TX (US)

(72) Inventors: Jagdish Jethmalani, Irving, TX (US); Rishi Pampati, Frisco, TX (US); Rudolf Suter, Dallas, TX (US)

(21) Appl. No.: 14/681,841

(22) Filed: Apr. 8, 2015

Related U.S. Application Data
(60) Provisional application No. 61/977,342, filed on Apr. 9, 2014.
(60) Provisional application No. 62/042,684, filed on Aug. 27, 2014.

(51) Int. Cl. G02C 13/00; G02C 7/02

(52) U.S. Cl. CPC G02C 13/005; G02C 7/027; G02C 7/028

(57) ABSTRACT

A method of virtually fitting an eyeglass frame is disclosed. A virtual try-on module receives an image of a user wearing an existing eyeglass frame from a user device; determines eyeglass frame dimension information; determines pupil diameter and segment height; determines a set of frames based on a bridge dimension; and sends the determined set of frames to the user device for display. Another method of virtually fitting an eyeglass frame to a user is also disclosed. A virtual try-on module receives image and eyeglass frame dimension information; determines pupil diameter and segment height; provides a sample set of eyeglass frames, each eyeglass frame in the set of eyeglass frames having lenses with pad printer marks; determines a subset of the sample set of eyeglass frames; and sends the determined subset of frames to the user device for display on the user device of the user.

### CROSS-REFERENCE TO RELATED APPLICATIONS

This application claims the priority, under 35 U.S.C. §119, of copending U.S. Provisional Patent Application Nos. 61/977,342, filed Apr. 9, 2014 and 62/042,684, filed Aug. 27, 2014; the prior applications are herewith incorporated by reference herein in their entireties.

### STATEMENT REGARDING FEDERALLY SPONSORED RESEARCH OR DEVELOPMENT

Not Applicable

### FIELD OF THE INVENTION

The present systems and methods lies in the field of eyewear fitting. The present disclosure relates to a method and system for virtual try-on and measurement of eyeglass frames.

### BACKGROUND OF THE INVENTION

Various methods have been developed to provide online three-dimensional virtual try-on of eyeglass frames. Templates such as credit card, a ruler, or an object with known dimensions are used for determining pupil distance (PD) and segment height (Seg Ht). None of the prior art methods are accurate, precise, and reproducible. Comfort and fit on frame purchased based on virtual try-on is an issue and a major cause of customer dissatisfaction/returns. An alternate process involves shipping frames to the customer for try-on. However, this process adds more logistics cost.

Thus, a need exists to overcome the problems with the prior art systems, designs, and processes as discussed above.

### SUMMARY OF THE INVENTION

The systems and methods described provide a virtual try-on method that overcomes the hereinafore-mentioned disadvantages of the heretofore-known devices and methods of this general type and that provide such features with an accurate and precise tool that allows the wearer to obtain frame, PD, Seg Ht, and tilt measurements without the need for a template.

With the foregoing and other objects in view, there is provided, a method of virtually fitting an eyeglass frame. A virtual try-on module running on a server is provided. The virtual try-on module uses a processor of the server to: receive an image of a user wearing an existing eyeglass frame from a user device; determine eyeglass frame dimension information; determine pupil diameter and segment height from the image; determine a set of frames based on a bridge dimension; and send the determined set of frames to the user device for display on the user device of the user.

With the objects in view, there is also provided a method of virtually fitting an eyeglass frame to a user. A virtual try-on module running on a server is provided. The virtual try-on module uses a processor of the server to: receive image and eyeglass frame dimension information; determine pupil diameter and segment height from the image; provide a sample set of eyeglass frames, each eyeglass frame in the set of eyeglass frames having lenses with pad printer marks; determine a subset of the sample set of eyeglass frames by selecting frames where a bottom portion of the pupils of the user in the received image lines up with the bottom of the pad printer marks; and send the determined subset of frames to the user device for display on the user device of the user.

In accordance with another mode, the virtual try-on module provides at least one of image capture, image processing, marker detection, marker adjustment, and measurements based on pixel size and location.

In accordance with a further mode, the determined eyeglass frame dimension information is provided by the user.

In accordance with an added mode, the determined eyeglass frame dimension information is confirmed by the virtual try-on module.

In accordance with an additional mode, the eyeglass frame dimension information includes eye size, bridge size, and temple.

In accordance with yet another mode, pupil distance is determined by factoring in: a location of irises in the image; a location of the bridge in the image; and a distance between each iris and a middle of a nose bridge in the image.

In accordance with yet a further mode, pupil distance is determined by factoring in: pixel size and pixel location; and a bridge size.

In accordance with yet an added mode, the segment height is determined based on the location of the irises in the image.

In accordance with yet an additional mode, the pupil distance and the segment height limit an A box dimension and a B box dimension of the set of frames.

In accordance with again another mode, a selected frame of the set of frames is superimposed on the image of the user.

In accordance with again a further mode, the pad printer marks are pad printer oval marks.

In accordance with again an added feature, a perspective angle is computed and corrected.

In accordance with a concomitant mode, the ovals are 27 mm to 35 mm in width and 12 mm to 22 mm in height. The reason for the wide range of oval dimensions is due to the fact that the diameter of the human iris average is 12 mm and the minimum height from the center of pupil to top of frame is 10 mm.

Although the systems and methods are illustrated and described herein as embodied in a virtual try-on and measurement system, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems and methods.

Additional advantages and other features characteristic of the systems and methods will be set forth in the detailed description that follows and may be apparent from the detailed description or may be learned by practice of exemplary embodiments. Still other advantages of the systems and methods may be realized by any of the instrumentalities, methods, or combinations particularly pointed out in the claims.

Other features that are considered as characteristic for the systems and methods are set forth in the appended claims. As required, detailed embodiments of the systems and methods are disclosed herein; however, it is to be understood that the disclosed embodiments are merely exemplary of the systems and methods, which can be embodied in various forms. Therefore, specific structural and functional details disclosed herein are not to be interpreted as limiting, but merely as a basis for the claims and as a representative basis for teaching one of ordinary skill in the art to variously employ the systems and methods in virtually any appropriately detailed structure. Further, the terms and phrases used herein are not intended to be limiting; but rather, to provide an understandable description of the systems and methods. While the specification concludes with claims defining the systems and methods of the invention that are regarded as novel, it is believed that the systems and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems and methods. Advantages of embodiments of the systems and methods will be apparent from the following detailed description of the exemplary embodiments thereof, which description should be considered in conjunction with the accompanying drawings in which:

FIG. 1 is a block diagram of an exemplary embodiment of a system for providing virtual try-on of eyeglass frames;

FIG. 2 is an exemplary illustration an eyeglass frame and eyeglass frame measurements;

FIG. 3 is a block diagram illustrating a method in accordance with an exemplary embodiment;

FIG. 4 is an exemplary illustration of an eye size measurement;

FIG. 5 is an exemplary illustration of an eyeglass frame showing a bridge width and determination of pupil distance using the bridge width as known parameter;

FIG. 6 is an exemplary illustration of a bridge width and determination of Seg Ht using the bridge width as known parameter;

FIG. 7 is an exemplary illustration of a set of frames;

FIG. 8 is an exemplary illustration of a set of frames;

FIG. 9 is an exemplary illustration of an eyeglass frame showing a bridge width and pupil distance of subject's original frame;

FIG. 10 is an exemplary illustration of an eyeglass frame selected from FIG. 7 Model 5 as an alternate frame that the subject chooses for Virtual Try-On based on the bridge width dimensions of 16 mm showing a bridge width and pupil distance;

FIG. 11 is an exemplary illustration of an eyeglass frame selected from FIG. 8 Model 16 as an alternate frame that the subject chooses for Virtual Try-On based on the bridge width dimensions of 17 mm showing a bridge width and pupil distance;

FIG. 12 is an exemplary illustration of an eyeglass frame selected as an alternate frame that the subject chooses for Virtual Try-On based on the bridge width dimensions of 18 mm showing a bridge width and pupil distance;

FIG. 13 is a block diagram illustrating a method in accordance with an exemplary embodiment;

FIG. 14 is an exemplary illustration of an eye size measurement and pad printer marks of known dimensions;

FIG. 15 is an exemplary illustration of an eyeglass frame showing a bridge width and determination of pupil distance using the bridge width and the pad printer mark dimensions as known parameter;

FIG. 16 is an exemplary illustration of an eyeglass frame showing a bridge width and determination of segment height using the bridge width and the pad printer mark dimensions as known parameter;

FIG. 17 is an exemplary illustration of a set of frames;

FIG. 18 is an exemplary illustration of a set of frames;

FIG. 19 is an exemplary illustration of an eyeglass frame showing a bridge width and pupil distance of subject's original frame;

FIG. 20 is an exemplary illustration of an eyeglass frame selected from FIG. 17 Model 5 as an alternate frame that the subject chooses for Virtual Try-On based on the bridge width dimensions of 16 mm and the pad printer marks so that the progressive lens design can be fitted precisely showing a bridge width and pupil distance;

FIG. 21 is an exemplary illustration of an eyeglass frame selected from FIG. 18 Model 16 as an alternate frame that the subject chooses for Virtual Try-On based on the bridge width dimensions of 17 mm and the pad printer marks so that the progressive lens design can be fitted precisely showing a bridge width and pupil distance;

FIG. 22 is an exemplary illustration of an eyeglass frame selected as an alternate frame that the subject chooses for Virtual Try-On based on the bridge width dimensions of 18 mm and the pad printer marks so that the progressive lens design can be fitted precisely showing a bridge width and pupil distance;

FIG. 23 shows a progressive lens design in a 75 mm blank where the major reference points (MRP) are located 17 mm apart from the geometric center and the distance power region is located in the top half of the lens and the progression in add power is located in the bottom half of the lens;

FIG. 24 shows the fitting of the Progressive design in the frame with 10 mm from the fitting cross to the top of the frame when the pad printed oval is located in a manner that the bottom of the pupil lines up with the bottom of the pad printed oval

FIG. 25 shows an exemplary captured image where the face is rotated slightly in three dimensions; and

FIG. 26 shows an application of perspective angle to the determination of the pupil distance.

### DETAILED DESCRIPTION OF THE INVENTION

As required, detailed embodiments of the systems and methods are disclosed herein; however, it is to be understood that the disclosed embodiments are merely exemplary of the systems and methods, which can be embodied in various forms. Therefore, specific structural and functional details disclosed herein are not to be interpreted as limiting, but merely as a basis for the claims and as a representative basis for teaching one skilled in the art to variously employ the systems and methods in virtually any appropriately detailed structure. Further, the terms and phrases used herein are not intended to be limiting; but rather, to provide an understandable description of the systems and methods. While the specification concludes with claims defining the features of the systems and methods that are regarded as novel, it is believed that the systems and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems and methods will not be described in detail or will be omitted so as not to obscure the relevant details of the systems and methods.

Before the systems and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, and top/bottom. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the systems and methods described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the systems and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The present disclosure describes an online process that allows a wearer of eyeglasses to determine accurate and precise PD, Seg Ht, and tilt with existing eyeglass frames and without the need to use a template.

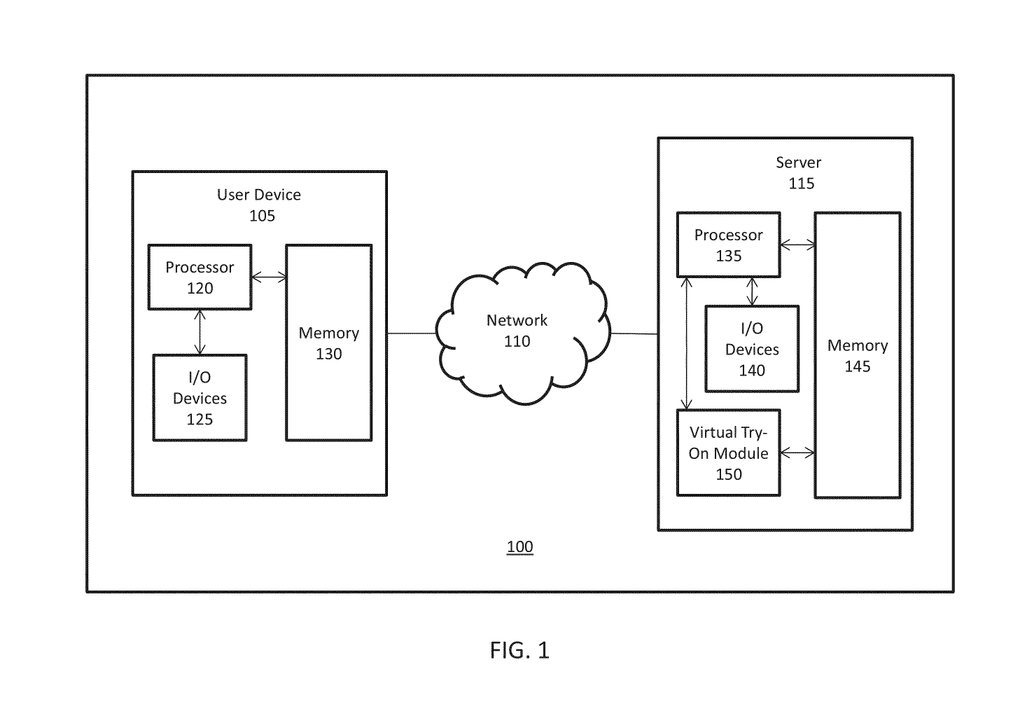

Described now are exemplary embodiments. Referring now to the figures of the drawings in detail and first, particularly to FIG. 1, there is shown a first exemplary embodiment of a system for providing virtual try-on for a user. System 100 includes a user device 105, a network 110, and a server 115.

User device 105 includes a processor (CPU) 120, memory 130 (e.g., random access memory (RAM) and/or read only memory (ROM)), and various input/output (I/O) devices 125 (e.g, a display, a receiver, a transmitter, and other devices commonly required to transmit and/or receive information over a wireless and/or wired link). I/O devices 125 also include components for a camera device that is used to take pictures or capture video. Camera 125 can be built in to the user device 105 or operate as a stand-alone device connected to the user device. Example user devices include, but are not limited to, a laptop computer, a desktop computer, and a mobile device, e.g., a tablet or a phone. Each of the devices requires the use of a front facing camera.

Server 115 includes a processor (CPU) 135, memory 145 (e.g., random access memory (RAM) and/or read only memory (ROM)), a virtual try-on module 150, and various input/output (I/O) devices 140 (e.g, a receiver, a transmitter, and other devices commonly required to transmit and/or receive information over a wireless and/or wired link). Server 115 can be a physical server or a cloud-based server.

User device 105 can be any computing device capable of communicating information over network 110 to server 115. User device 105 communicates with server 115 through a web browser or virtual try-on application stored in the memory 130 of the user device. In one embodiment, network 110 can be the internet or any other network capable of allowing user device 105 to communicate with server 115.

The virtual try-on module 150 and/or virtual try-on application has algorithms that involve image capture, image processing, marker detection, marker adjustment, measurements based on pixel size and location, etc.

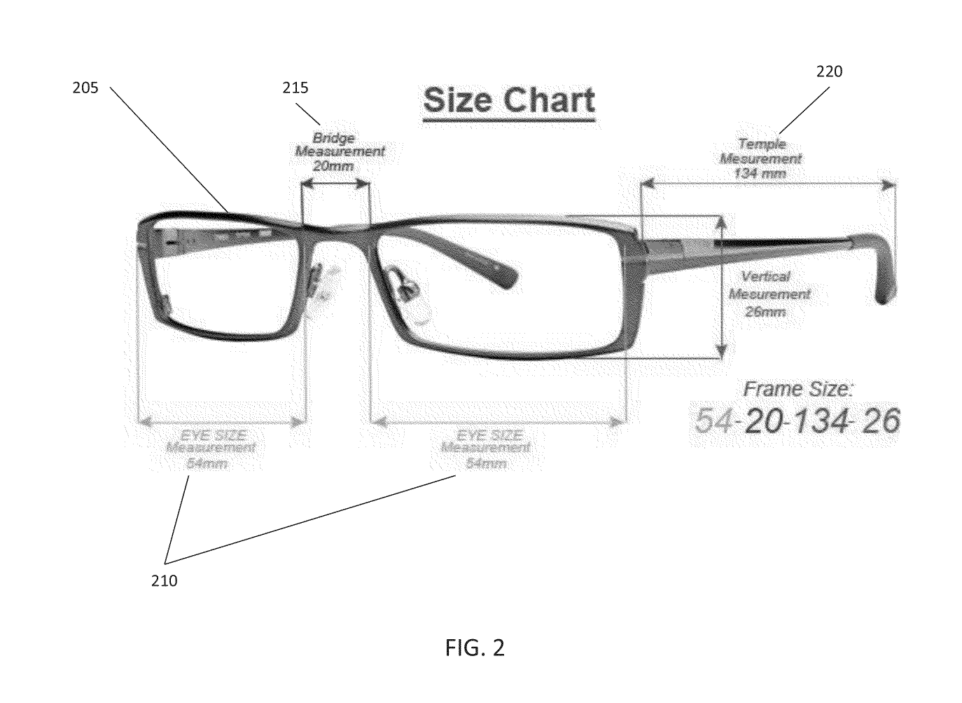

FIG. 2 shows an eyeglass frame 205 and the measurements needed to provide a proper fit using the inventive virtual try-on application of the present disclosure. Virtual try-on module 150 uses two-dimensional or three-dimensional processing software and incorporates frame dimensions provided by a user. The frame dimensions needed by the virtual try-on module 150 are eye size 210, bridge size 215, and temple 220. The wearer of the frame can review the temple of the frame to obtain the measurements or determine the measurements as shown in FIG. 2. The wearer can also be directed to http//www.simplyeyeglasses.com/help/frame_size.php for further instructions on obtaining frame dimensions.

Eye size 210 is the size of a lens hole on a frame where the horizontal dimension of 54 mm and vertical dimension 26 mm are reported. Bridge size 215 is the shortest horizontal distance between the two lenses in a given frame. The temple 220 is the part of the frame that extends from the end piece over the top of the ear and which gives support to the frame.

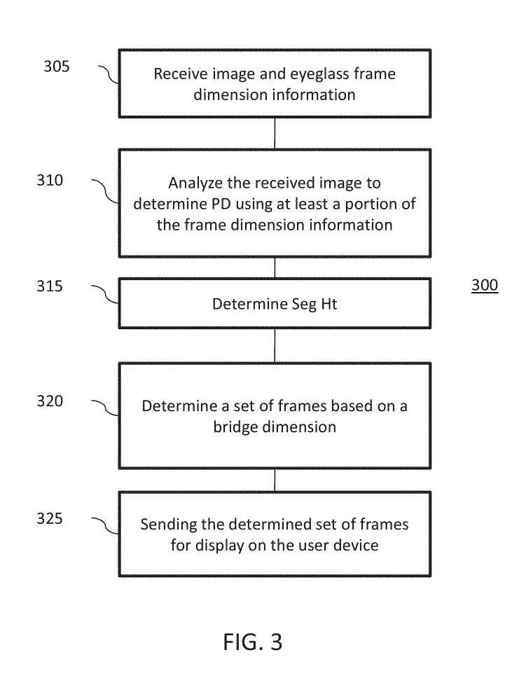

FIG. 3 illustrates a block diagram of a method for providing virtual try-on and measurement. Method 300 begins at block 305. At block 305 at least one image is received along with eyeglass frame dimension information from user device 105 by server 115. The wearer takes at least one image, e.g., using user device 105, while wearing an existing eyeglass frame. The wearer provides eyeglass frame dimension information, e.g., eyesize, bridge, and temple dimensions, for their existing eyeglass frame by reading the information located on the temple of their eyeglass frame. The frame dimensions can be confirmed by reviewing the frame manufacturer, frame brand name, UPC code, etc if the frame exists in the frame database such as one from Jobson or Frames Direct (http://www.framesdata.com) that can be accessed via web services. The incorrect information may be overwritten by the correct data if the user does not enter the correct information. The one or more images and the eyeglass frame dimension information is received by server 115 from user device 105 over network 110.

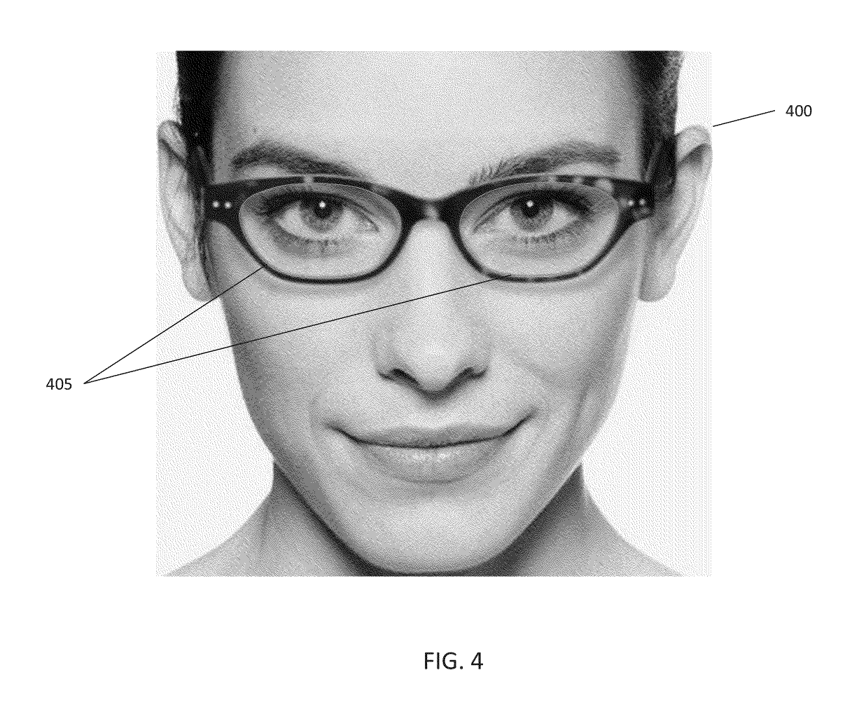

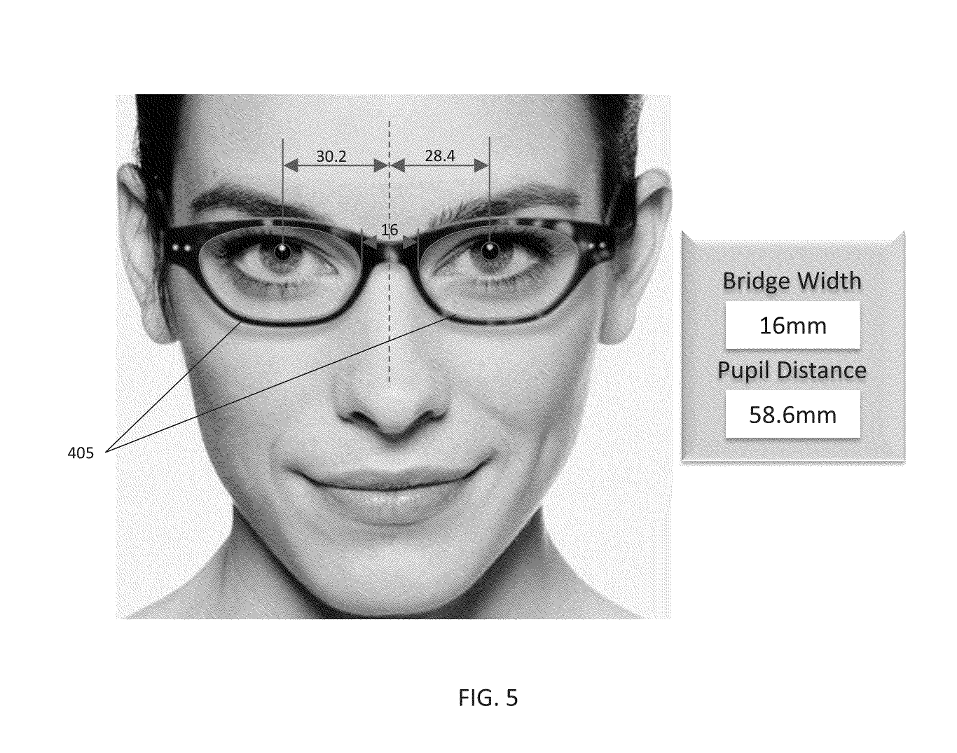

At block 310, the received image is analyzed to determine PD using at least a portion of the frame dimension information. FIG. 4 shows an eye size measurement on an example image received from a user. The virtual try-on module 150 determines the eye size 405 of the eyeglass frame in the received image 400. FIG. 5 shows an eyeglass frame having a bridge width provided by the user. The bridge width and the determined PD are shown superimposed on the image received from the user. In this example, the bridge width entered by the user is 16 mm. The virtual try-on module 150 determines a location of the irises of a user in the image. The virtual try-on module also determines a location of the bridge. The virtual try-on module 150 analyzes the wearer image to determine the PD using the bridge dimensions provided by the user. The bridge dimensions of 16 mm corresponds to 0.53 inch and the distance between the right iris and the middle of nose bridge is 1 inch. Hence the determined pupil distance for right eye is 1 inch/0.53 inch*16 mm=30.19 mm (reported as 30.2 mm). Similarly for the left eye the distance between the left iris and the middle of the nose bridge is 0.94 inch. Hence the determined pupil distance for left eye is 0.94 inch/0.53 inch*16 mm=28.38 mm (reported as 28.4 mm). Hence the final pupil distance of the example shown in FIG. 5 is 58.6 mm. Other methods may use image processing algorithm where the measurement is based on pixel size and pixel location to determine the PD based on the provided nose bridge width. An alternate method would involve image processing algorithms which determines blob analysis and its variant. For example the captured user image can be pixelated and the start at the top left corner is represented as (0,0). As one moves across the horizontal dimension, the numbers change from (0,0) to (0,1 . . . 10,000). As one moves down the vertical dimension, the numbers change from (0,0) to (1 . . . 10,000,0). The location of the nose bridge starting point may be (2500, 550) and the end may be (3500, 550). This will mean that the nose bridge is 1000 pixels wide and these 1000 pixels corresponds to 16 mm of nose bridge width. Once that is set then the center of irises (PD) can be determined. For PD determination, the center of left pupil may be (500,650) and the center of right pupil may be (4162.5, 650). The pupil distance can be determined as 4162.5−500=3662.5/1000=3.6625*16 mm=58.6 mm.

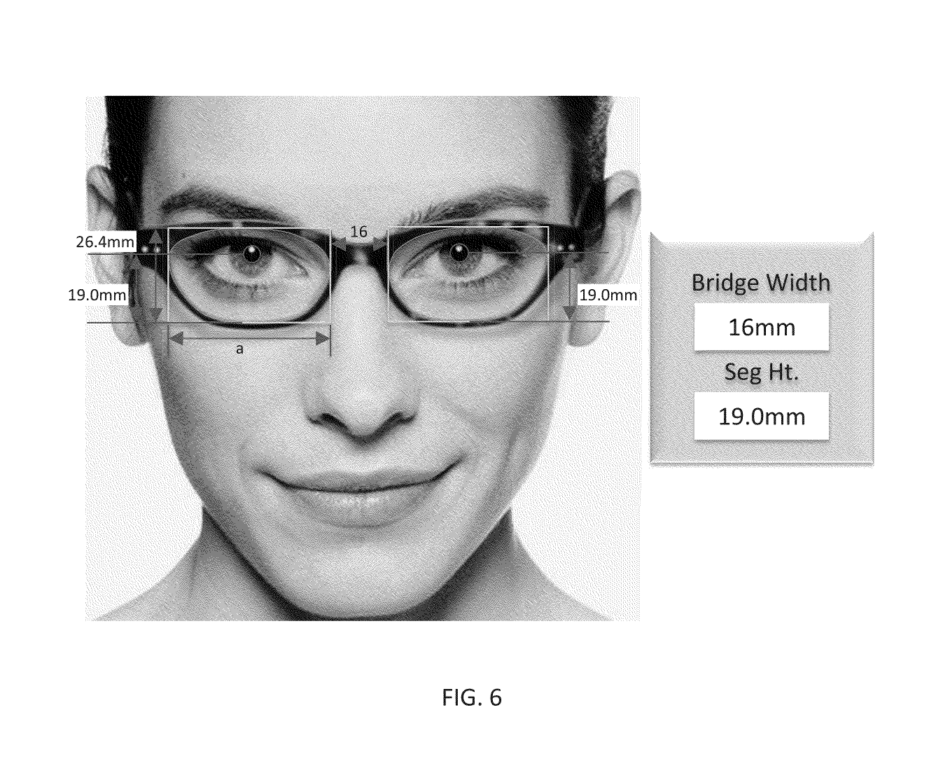

At block 315, the virtual try-on module determines the Seg Ht. The Seg Ht is determined based on the location of the iris(es) in the image. In the embodiment shown in FIG. 6, the bridge dimensions of 16 mm corresponds to 0.54 inch and the vertical height of rectangular box covering the eye-size is measured at 0.89 inch. The vertical height is determined as 0.89 inch/0.54 inch*16 mm=26.37 mm (reported 26.4 mm). The middle of the iris to the bottom of the rectangular box is 0.64 inch and the Seg. Ht is determined as 0.64 inch/0.54 inch*16 mm=18.96 mm (reported 19.0 mm). FIG. 6 is an exemplary illustration of a bridge width and determination of Seg Ht using the bridge width as known parameter. FIG. 6 shows a bridge width and Seg Ht measurement superimposed on the image received from the user.

At block 320, the virtual try-on module determines a set of frames based on a bridge dimension. In one embodiment, the set of frames is determined from a user provided bridge dimension. In one embodiment, the set of frames is determined from frames having a bridge dimension 1 mm to 2 mm larger than the user provided bridge dimension. The PD and Seg Ht along with the prescription (mostly progressive) may only limit the A box dimension and the B box dimension of the frame. In one embodiment, the set of frames includes frames having the user provided bridge dimension and frames having a larger bridge dimension. The reason for using larger bridge dimensions is that it will fit over the nose bridge and slide upwards or downwards by adjusting the adjustable nose pad—this helps fitting the progressive lens design properly on the user's face. If one may choose to use frames with smaller nose bridge width then either the frame may not fit the user's nose bridge and the option to slide the frame upwards or downwards is not possible.

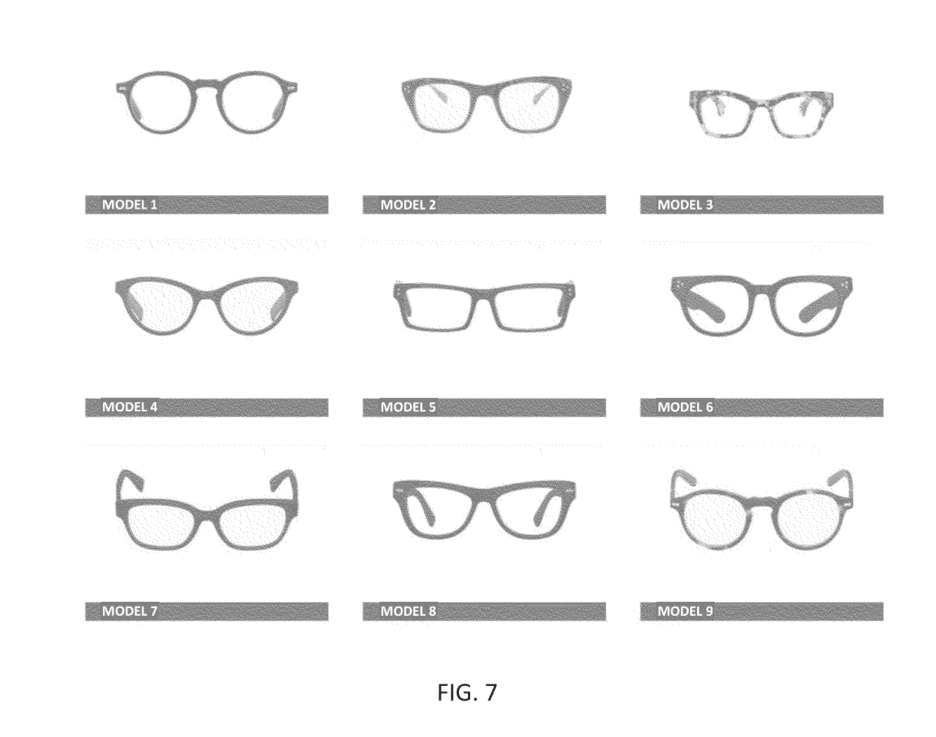

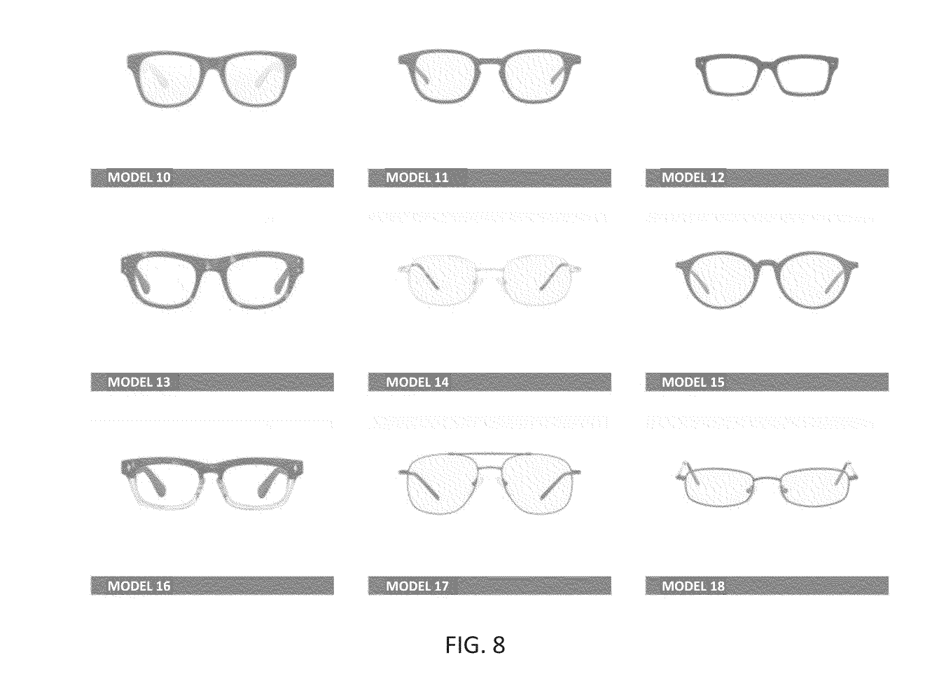

At block 325, the determined set of frames is sent by the server 115 to be displayed to the user on user device 105. FIG. 7 and FIG. 8 show example frames that are sent for display by the user. FIG. 7 shows eyeglass frames MODEL 1 to MODEL 9 and FIG. 8 shows eyeglass frames MODEL 10 to MODEL 18.

In one embodiment, the user is allowed to superimpose each try-on frame of the set of frames on the captured image. In this embodiment, the user is able to determine how a selected frame would look when worn by the user.

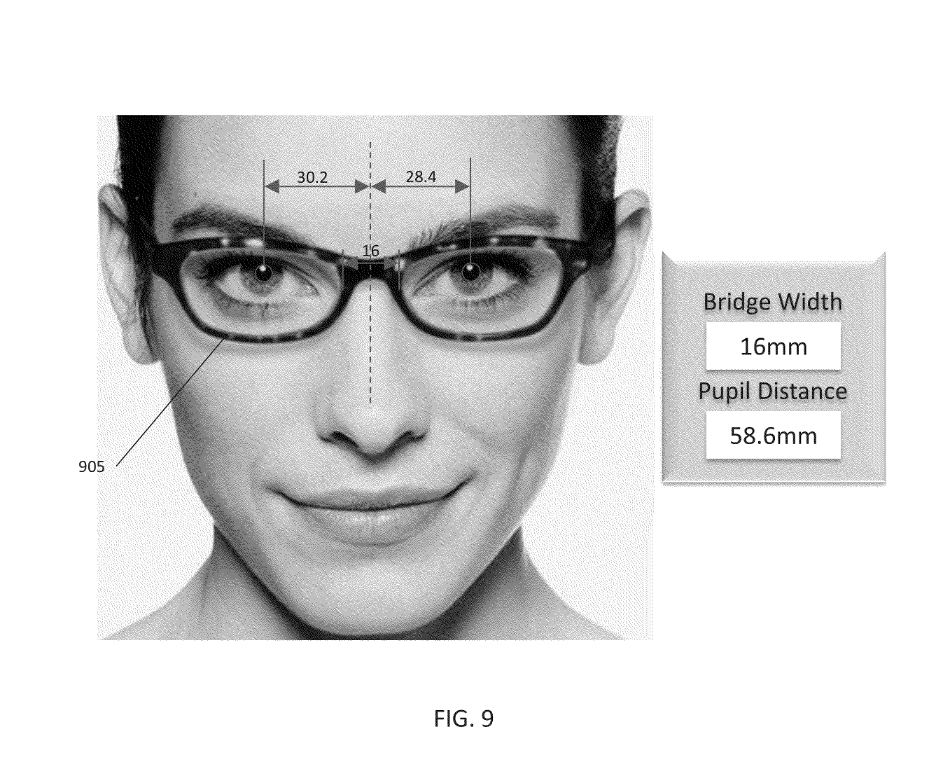

FIG. 9 shows the original frame superimposed on a user's face in the image. The new frame 905 has the user provided nose bridge width and PD is determined for the user's existing eyeglass frame.

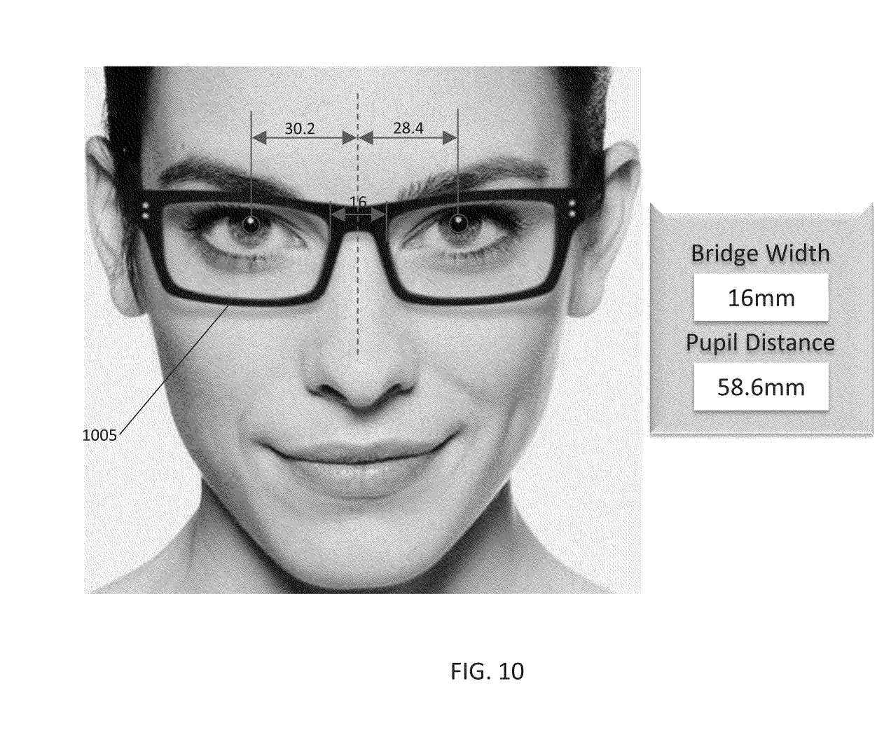

FIG. 10 shows a new frame superimposed (Model 5 with nose bridge width of 16 mm from FIG. 7) on a user's face in the image. The new frame 1005 has the same bridge width and is aligned according to the same PD measured for the user's existing eyeglass frame.

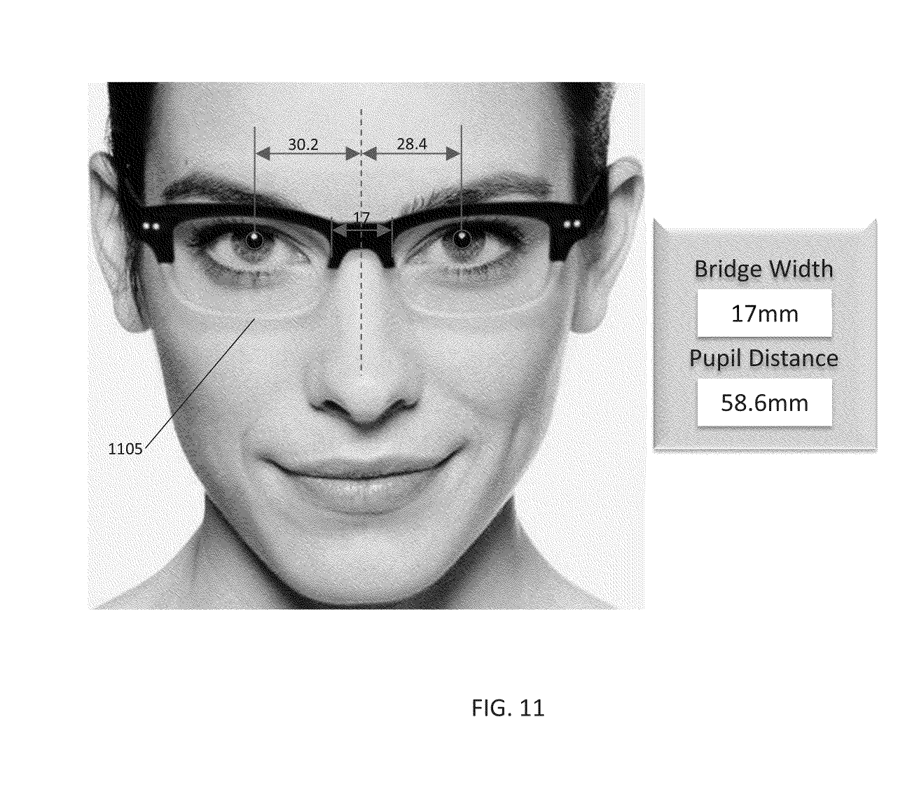

FIG. 11 shows a new frame superimposed (Model 16 with nose bridge width of 17 mm from FIG. 8) on a user's face in the image. The new frame 1105 has a larger bridge width, e.g., 17 mm, and is aligned according to the same PD measured for the user's existing eyeglass frame.

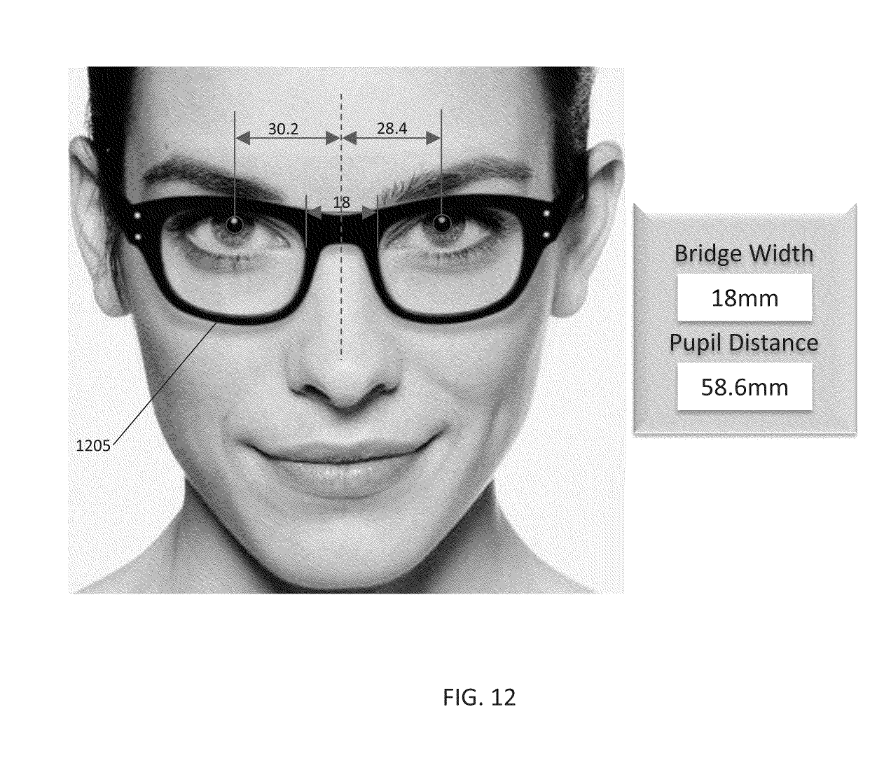

FIG. 12 shows a new frame superimposed (nose bridge width of 18 mm) on a user's face in the image. The new frame 1205 has an even larger bridge width, e.g., 18 mm, and is aligned according to the same PD measured for the user's existing eyeglass frame.

In one embodiment, when multiple images are provided by the user, the virtual try-on module 150 allows a user to turn their head and capture images from a different point of view. The 3D virtual try-on and rotation of the user with the frame mounted on their face allows determining the fit of the frame where the temples are wrapped around the ears, the nose bridge is touching the nose, the frame is located properly on the nose bridge, the pantoscopic tilt, and the user's comfort to the new frames without actually wearing the real frames. Additionally the present embodiment includes the fitting of progressive lens design virtually to the user's face where the proper fitting height is located with the user's line of sight so that the best vision is possible when the real lenses mounted eyeglass frames are provided to the user.

The present disclosure provides a short corridor design that accommodates a minimum fit height of 14 mm and a fitting cross located at 4 mm. Short corridor lenses provide reading zones that are higher in the frame and are typically made to fit in smaller vertical dimension (B box) eyeglass frames. Fit height measures from a center of a pupil to a bottom of the lens. The fitting cross is the location on a progressive lens that is normally fit in front of the pupil center. The fitting cross is usually 2-4 mm above the major reference point (MRP) or optical center of the lens. The present disclosure allows for a distance between the fitting cross and a top of the frame to be 10 mm. Frames with adjustable nose pads work best with this process as these types of frames can be adjusted to move the progressive channel up or down to fit the wearer's need. The progressive channel is the aspheric corridor of a progressive lens that makes up the intermediate and near vision zones.

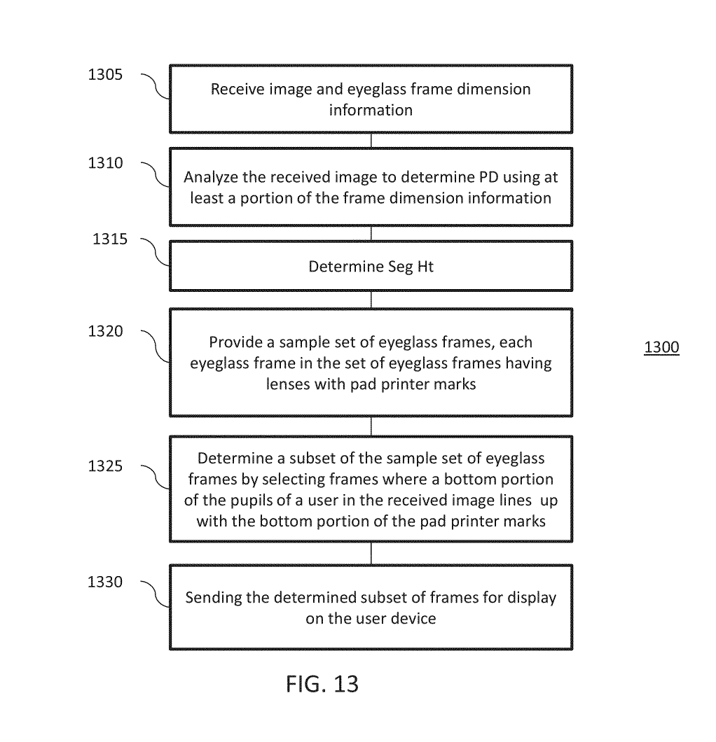

FIG. 13 illustrates a block diagram of a method for providing virtual try-on and measurement. Method 1300 begins at block 1305. At block 1305 at least one image is received along with eyeglass frame dimension information from user device 105 by server 115. The wearer takes at least one image, e.g., using user device 105, while wearing an existing eyeglass frame. The wearer provides eyeglass frame dimension information, e.g., eyesize, bridge, and temple dimensions, for their existing eyeglass frame by reading the information located on the temple of their eyeglass frame. The frame dimensions can be confirmed by reviewing the frame manufacturer, frame brand name, UPC code, etc if the frame exists in the frame database such as one from Jobson or Frames Direct (http://www.framesdata.com) that can be accessed via web services. The incorrect information may be overwritten by the correct data if the user does not enter the correct information. The one or more images and the eyeglass frame dimension information is received by server 115 from user device 105 over network 110.

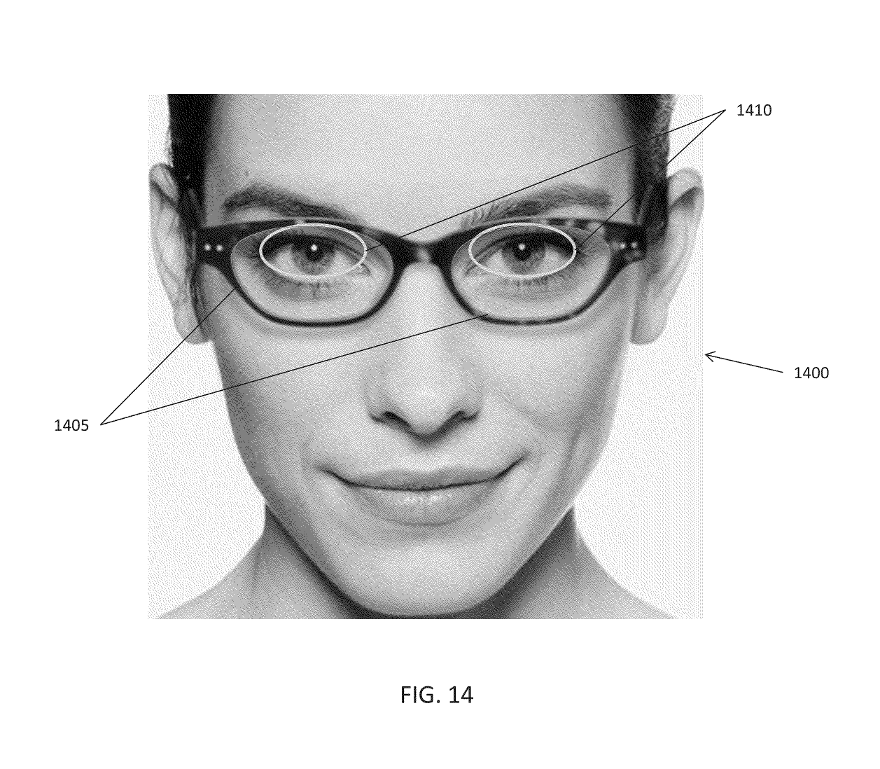

FIG. 14 shows an eye size measurement on an example image received from a user. The virtual try-on module 150 determines the eye size 1405 of the eyeglass frame in the received image 1400. Also included are virtual pad printer marks 1410 superimposed on the image.

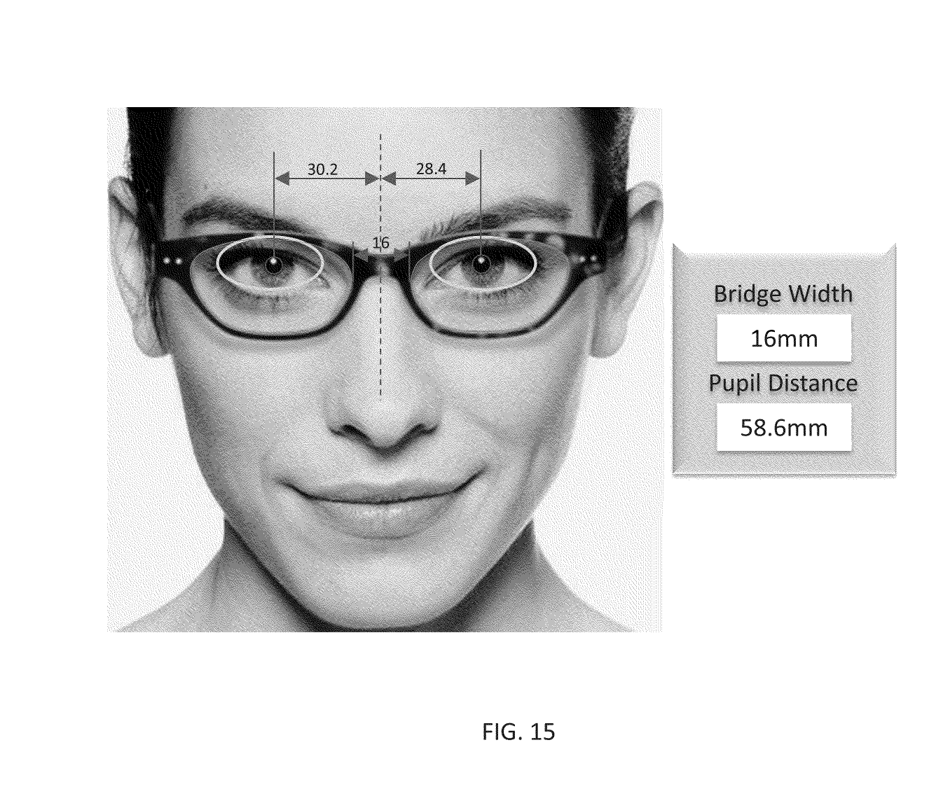

At block 1310, the virtual try-on module 150 analyzes the received image to determine PD using at least a portion of the frame dimension information. The PD can be determined as described above with respect to block 310 of FIG. 3. FIG. 15 shows an eyeglass frame having a bridge width provided by the user. The bridge width and the PD measurement are shown superimposed on the image received from the user. In this example, the bridge width entered by the user is 16 mm. The virtual try-on module 150 determines a location of the irises of a user in the image. The virtual try-on module also determines a location of the bridge. The virtual try-on module 150 analyzes the wearer image to determine the PD using the bridge and/or eye size dimensions provided by the user. The pupil distance of the example shown in FIG. 5 is 58.6 mm.

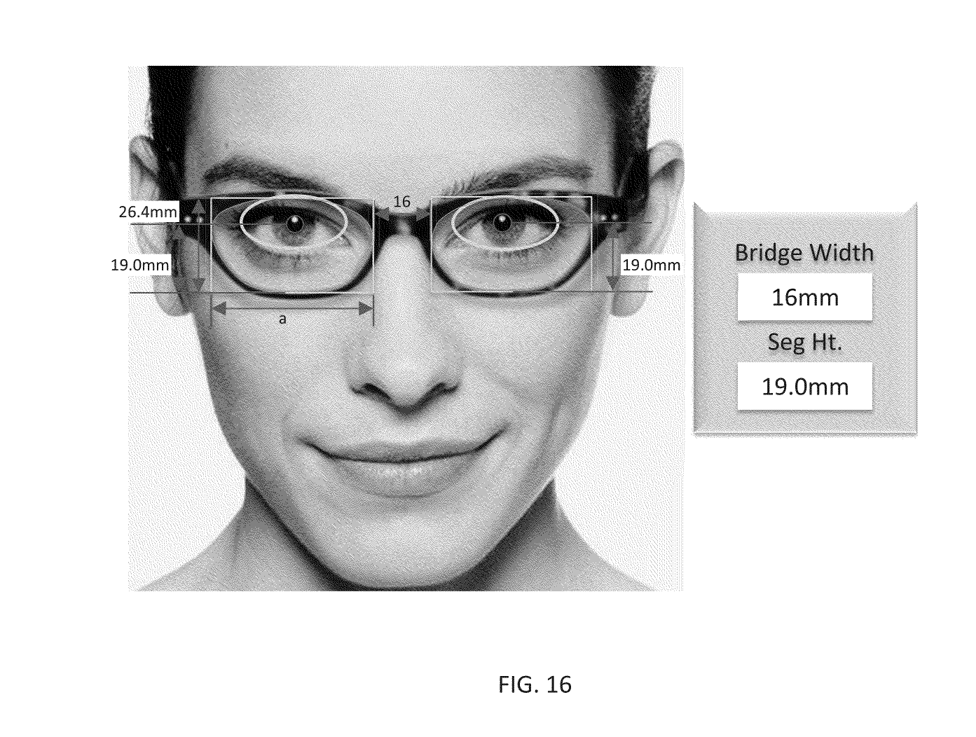

At block 1315, the virtual try-on module determines the Seg Ht. The Seg Ht can be determined as described above with respect to block 315 of FIG. 3. FIG. 16 shows a bridge width and Seg Ht measurement superimposed on the image received from the user.

At block 1320, a sample set of eyeglass frames is provided. The initial sample set of frames is determined based on a bridge description as described above with respect to block 320 of FIG. 3. In this embodiment, each eyeglass frame in the set of eyeglass frames has lenses with pad printer marks on them. In one embodiment, the pad printer marks are ovals. In one embodiment, the dimension of the ovals is 16 mm×30 mm. The specific range of oval dimensions is due to the fact that the diameter of the human iris average is 12 mm and ½ of the iris diameter is 6 mm. The difference between the oval vertical height of 16 mm and the iris diameter is 4 mm. Combining 6 mm+4 mm provides the minimum height from the center of pupil to top of frame is 10 mm. The ovals are placed on the lens such that a top portion of each oval touches a top edge of the frame.

At block 1325, the virtual try-on module determines a subset of the sample set of eyeglass frames by selecting frames where a bottom portion of the pupils of the user in the received image lines up with the bottom portion of the pad printer marks. In one embodiment, the pad printer marks are ovals and the virtual try-on module determines a subset of the sample set of eyeglass frames by selecting frames where a bottom portion of the pupils of the user in the received image lines up with the bottom portion of the pad printer oval marks. In one embodiment, where the pad printer marks are 16 mm×30 mm ovals, the two ovals touch the top edge of the frame. In order to ensure a proper fit to the patient's face, the bottom of each pupil of the patient should line up with the bottom curve of a respective corresponding oval pad printer mark. Frames that are part of the subset may include eyeglass frames having a user provided bridge dimension and/or a bridge dimension 1 mm to 2 mm larger than the user provided bridge dimension.

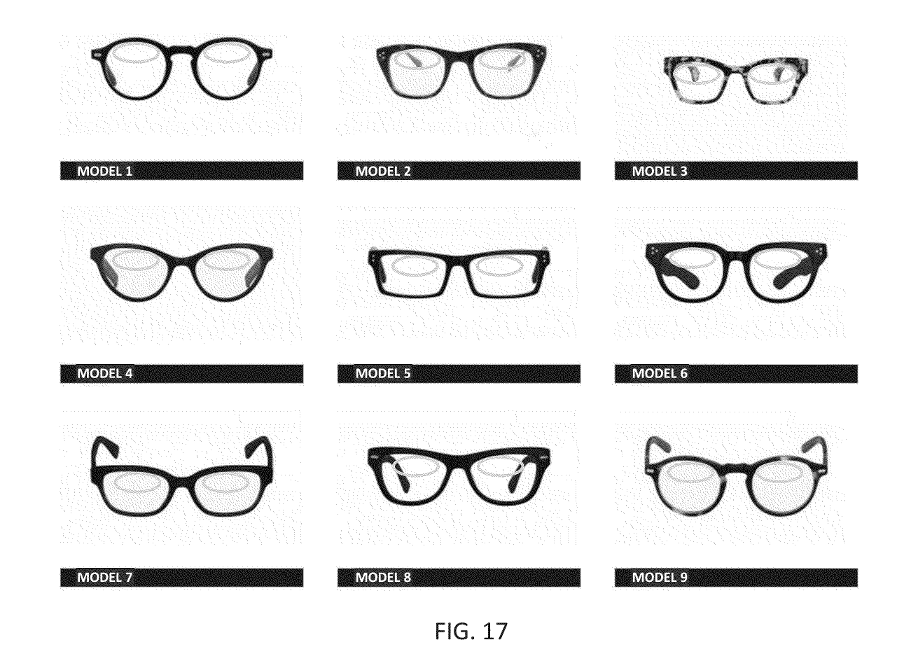

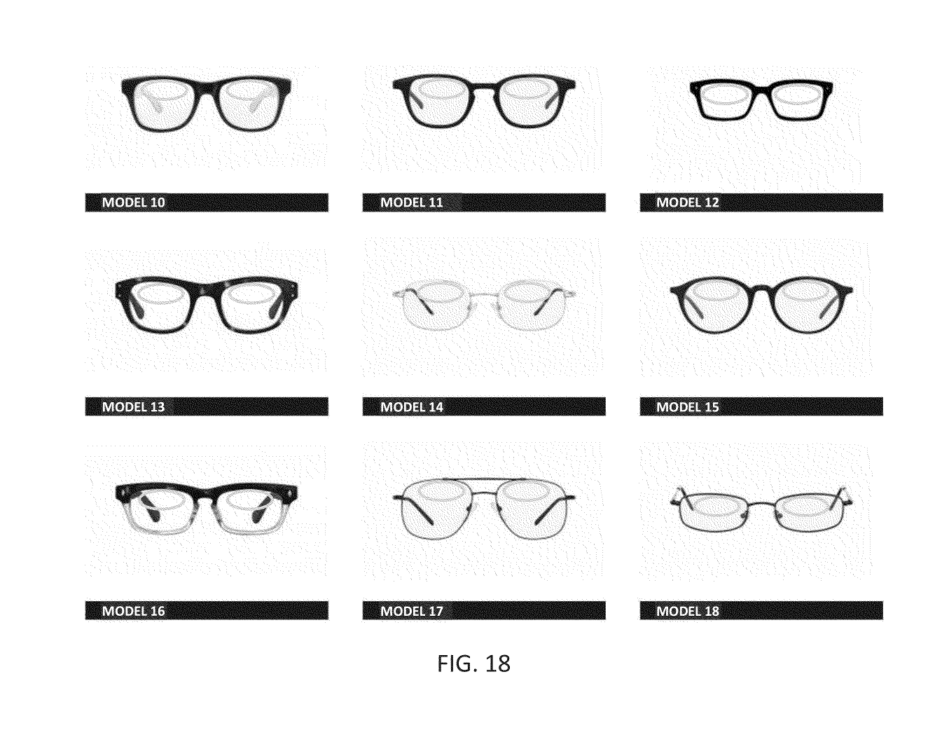

At block 1330, the determined subset of the sample set of eyeglass frames is sent by the server 115 to be displayed to the user on user device 105. FIG. 17 and FIG. 18 show example frames that are sent for display by the user. FIG. 17 and FIG. 18 illustrate a sample set of eyeglass frames having pad printer marks included on the lenses of each frame in the set of lenses. FIG. 17 shows eyeglass frames MODEL 1 to MODEL 9. FIG. 18 shows eyeglass frames MODEL 10 to MODEL 18.

In one embodiment, the user is allowed to superimpose each try-on frame of the subset of frames on the captured image. In this embodiment, the user is able to determine how a selected frame would look when worn by the user.

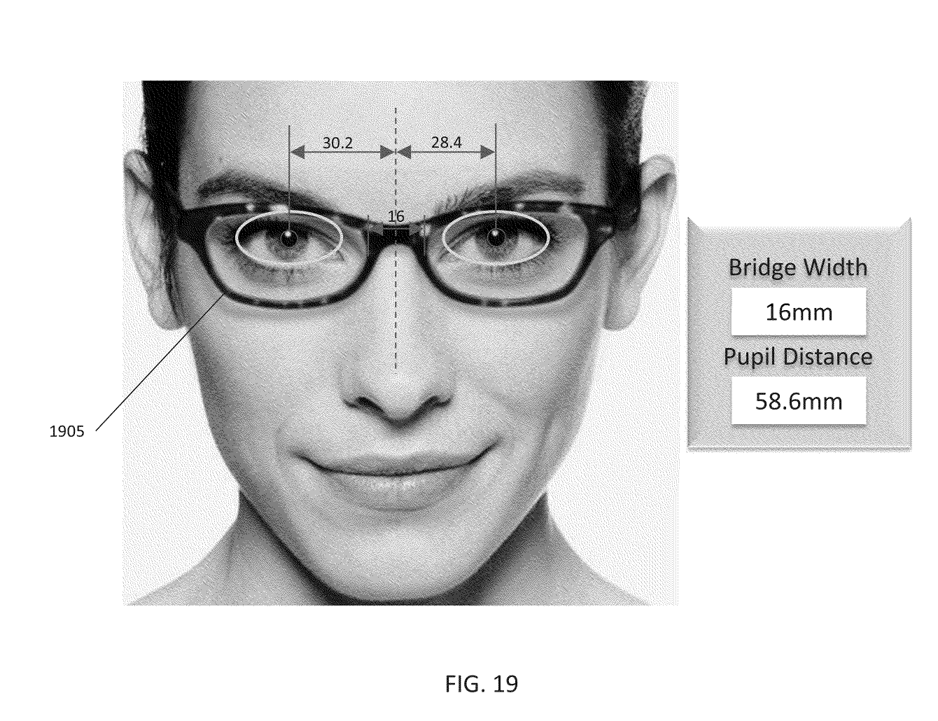

FIG. 19 shows the original frame superimposed on a user's face in the image. The frame 1905 has the same bridge width and is aligned according to the same PD measured for the user's existing eyeglass frame.

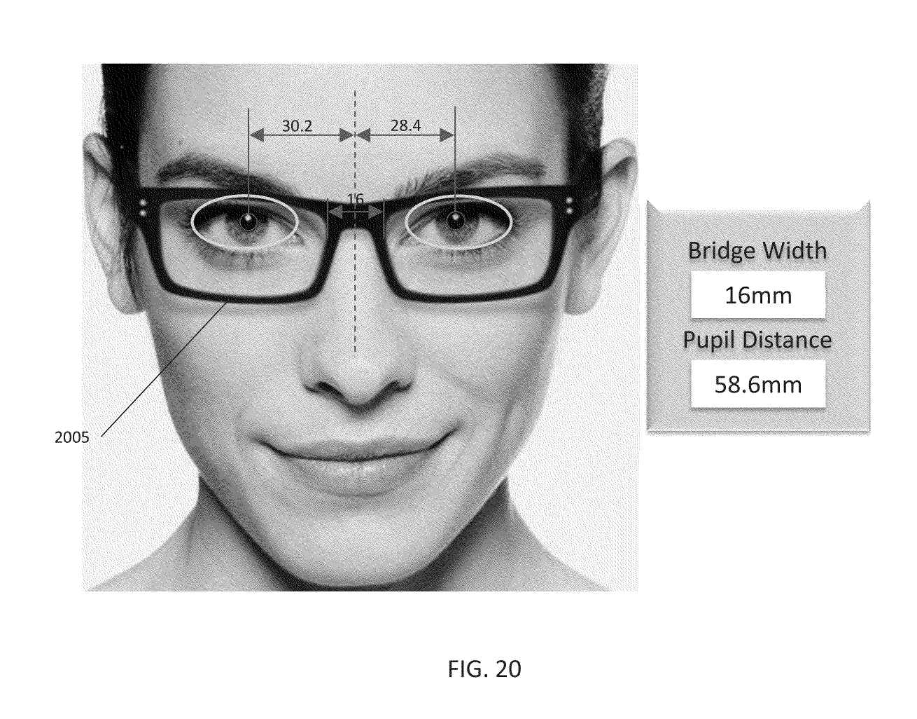

FIG. 20 shows a new frame superimposed (Model 5 with nose bridge width of 16 mm from FIG. 17) on a user's face in the image. The new frame 2005 has the same bridge width and is aligned according to the same PD measured for the user's existing eyeglass frame.

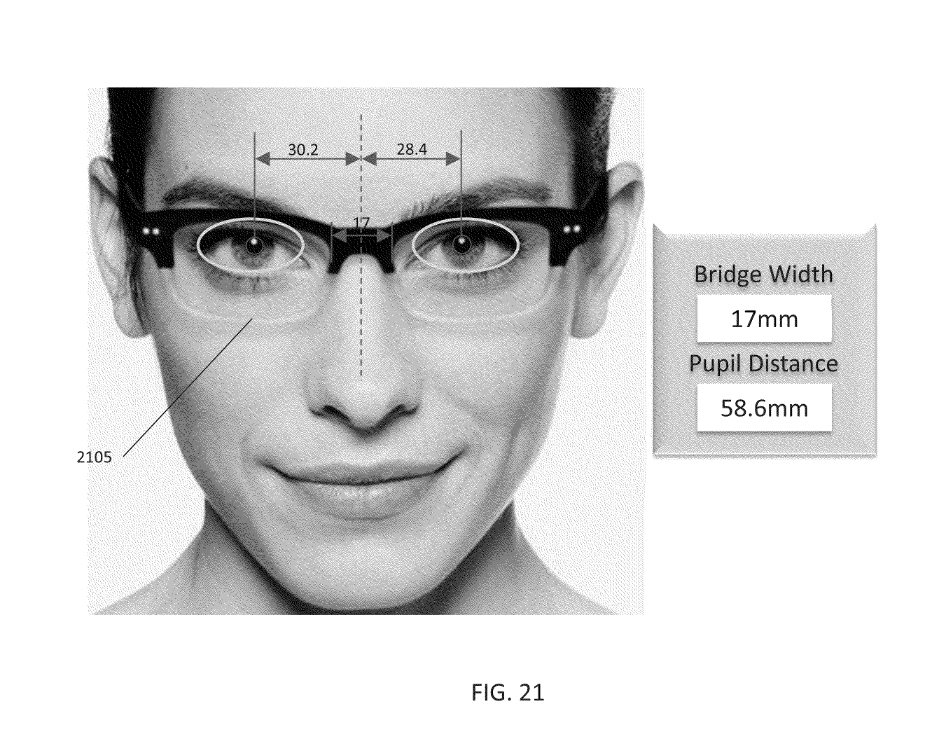

FIG. 21 shows a new frame superimposed (Model 16 with nose bridge width of 17 mm from FIG. 18) on a user's face in the image. The new frame 2105 has a larger bridge width, e.g., 17 mm, and is aligned according to the same PD measured for the user's existing eyeglass frame.

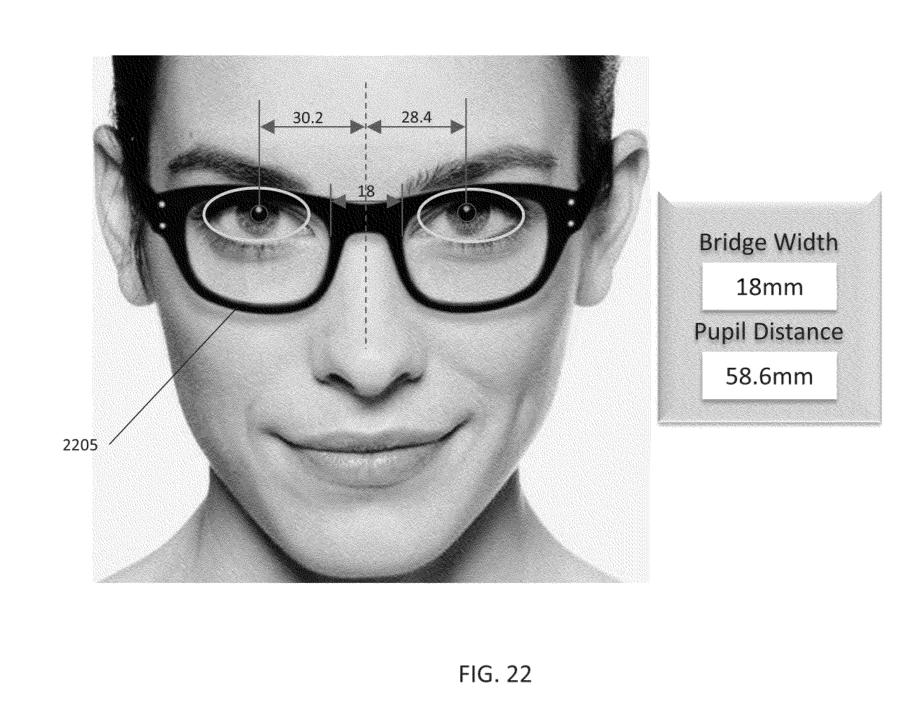

FIG. 22 shows a new frame superimposed (nose bridge width of 18 mm) on a user's face in the image. The new frame 2205 has an even larger bridge width, e.g., 18 mm, and is aligned according to the same PD measured for the user's existing eyeglass frame.

In one embodiment, when multiple images are provided by the user, the virtual try-on module 150 allows a user to turn their head and capture images from a different point of view. The 3D virtual try-on and rotation of the user with the frame mounted on their face allows determining the fit of the frame where the temples are wrapped around the ears, the nose bridge is touching the nose, the frame is located properly on the nose bridge, the pantoscopic tilt, and the user's comfort to the new frames without actually wearing the real frames. Additionally the present embodiment includes the fitting of progressive lens design virtually to the user's face where the proper fitting height is located with the user's line of sight so that the best vision is possible when the real lenses mounted eyeglass frames are provided to the user.

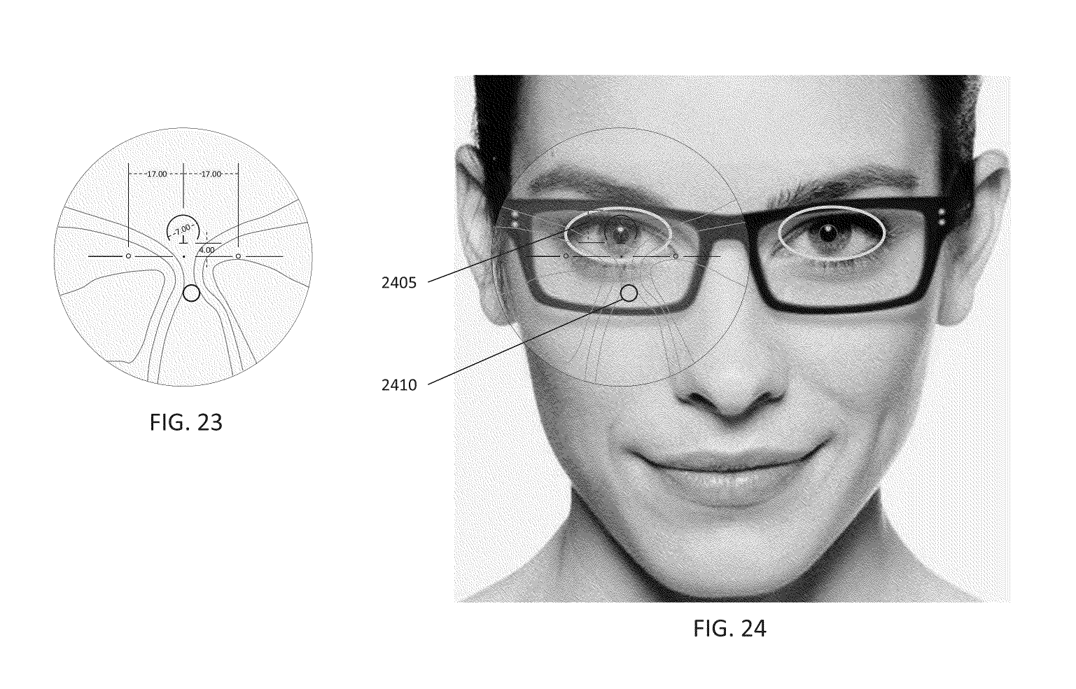

FIG. 23 shows a progressive lens design with astigmatic contours that lie on both left and right halves of the lens. FIG. 23 shows a progressive lens design in a 75 mm blank where the major reference points (MRP) are located 17 mm apart from the geometric center and the distance power region is located in the top half of the lens and the progression in add power is located in the bottom half of the lens. The present disclosure provides a progressive design that accommodates a minimum fit height of 16 mm and a fitting cross located at 4 mm. Short corridor lenses provide reading zones that are higher in the frame with the minimum fit height of 13-14 mm and are typically made to fit in smaller vertical dimension (B box) eyeglass frames. Fit height measures from a center of a pupil to a bottom of the lens. The fitting cross is the location on a progressive lens that is normally fit in front of the pupil center. The fitting cross is usually 2-4 mm above the major reference point (MRP) or optical center of the lens.

FIG. 24 shows the fitting of the Progressive design in the frame with minimum 10 mm from the fitting cross to the top of the frame when the pad printed oval is located in a manner that the bottom of the pupil lines up with the bottom of the pad printed oval. The present disclosure allows for a distance between the fitting cross and a top of the frame to be minimum 10 mm (shown as 2405 in FIG. 24). Frames with adjustable nose pads work best with this process as these types of frames can be adjusted to move the progressive channel up or down to fit the wearer's need. The progressive channel is the aspheric corridor of a progressive lens that makes up the intermediate and near vision zones. The add power 2410 is located inside the frame and any deviation of the pad printed oval from this arrangement will cause improper fitting of the progressive lens design.

The virtual try-on module provides precise fitting by placing a pad printer mark in the form of an oval that is 27-35 mm in width and 12-22 mm in height and preferably 28-30 mm in width and 15-18 mm in height. The user places the virtual frame on their captured image and aligns the frame by adjusting the oval height in such a way that the bottom of the oval is lined up with the edge of the pupil. This will ensure that the frame fit is correct on the user's face and the design will fit precisely to the user's need. This method allows one to have 10 mm of visual area from the top of the frame with the center of the pupil and this is the distance area of the progressive lens. From the center of the pupil to the bottom of the frame is the Seg Ht and this is the area where the progression in the additional power is seen in the progressive design and the full addition power is inside the frame. The above methods allow precise fitting of the progressive lenses virtually. If the bottom of the iris is lined to the bottom of the oval then the frames are located downwards from the user's line of sight and the lens design mounted in the frame will not fit well and the user will have compromised their vision needs.

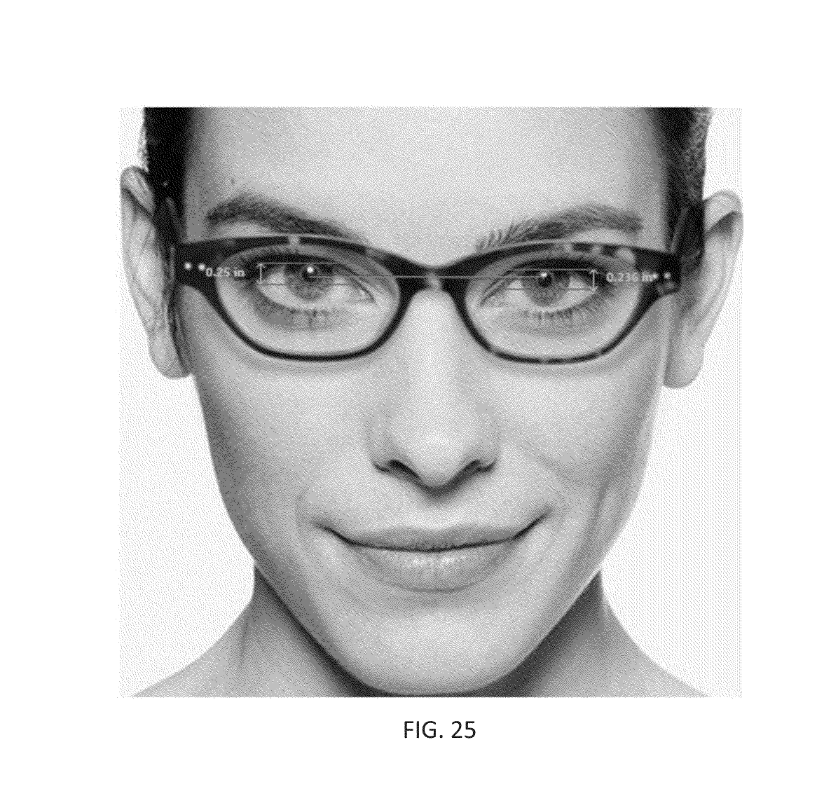

FIG. 25 shows an exemplary captured image where the face is rotated slightly in three dimensions. In FIG. 25, an example of an image captured where the face is rotated slightly in X and Y as well as Z directions. The difference in the heights of the pupil indicates the rotation along the Z axis and the difference in the position of the pupil center indicates the rotation along they X,Y axis.

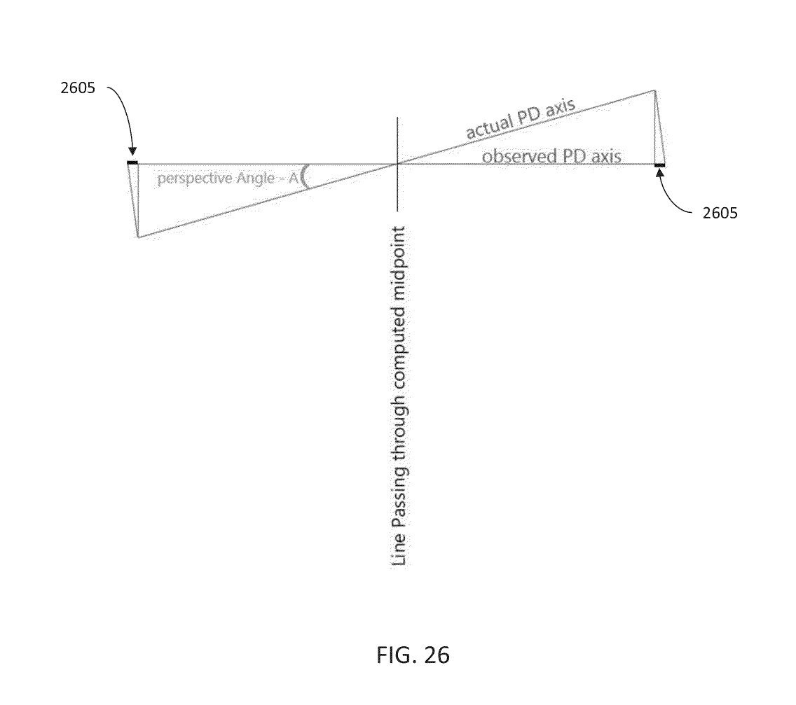

FIG. 26 shows an application of perspective angle to the determination of the pupil distance. The PD computed in the image in FIG. 25 will suffer from an error caused due to perspective angle (Z tilt) and XY rotation. To correct this issue, a transformation algorithm is needed.

The XY rotation can be nullified by finding the angle of rotation along XY. This angle is the same as the angular rotation of the line joining the center of the pupils and can be computed.

Once the angle is computed, the axis of rotation needs to be identified. The axis of rotation can be computed as one of the following: a midpoint computed horizontally between the edges of the frame, a center of the face, and a center of the nose.

After rotation of the image along the XY axis, the perspective angle needs to be computed and corrected. FIG. 26 shows a top view (along the Z axis) of the line connecting the centers of the pupil (the PD axis). The shift in the pupil center due to perspective angle can clearly be observed and so can the error 2605.

In order to compute the perspective, the image has to be rotated in increments of 0.01 degrees along the computed center horizontally until the diameters of both pupils match. After the perspective angle is measured, the actual PD (hypotenuse) can be computed by applying trigonometric formulae to the perspective angle (angle) and the observed PD (adjacent).

The perspective angle computation/correction can be applied to the methods disclosed in connection with FIG. 3 and FIG. 13. In one embodiment, when pad printed ovals are used, the height and width of the ovals can be utilized instead of the pupil diameters.

The virtual try-on module of the present disclosure provides many advantages. The virtual try-on module eliminates the need for an extra template to be used for determining PD and Seg Ht. The virtual try-on module involves using existing frames and uses bridge dimension and/or A and B box dimensions to determine the PD and Seg Ht. The virtual try-on module provides a new method that involves pad printing two ovals on the two lenses of an eyeglass frame so that the patient's, e.g., user's, pupil fits inside the two ovals and line up with the bottom curve of the ovals. The use of pad printing ensures that the eyeglass frames are fitted well on a patient's face. The virtual try-on module of the present disclosure resolves fit and comfort issues with online ordering portals and current processes because there is no requirement to follow the bridge dimensions provided by the end user.

The processes described above, including but not limited to those presented in connection with FIGS. 3 to 26, may be implemented in general, multi-purpose, or single purpose processors. Such a processor, e.g. processor 120, 135, will execute instructions, either at the assembly, compiled, or machine-level, to perform that process. Those instructions can be written by one of ordinary skill in the art following the description of presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), and/or packetized or non-packetized wireline or wireless transmission signals.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems and methods. However, the systems and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems and methods as defined by the following claims.

What is claimed is:

1. A method of virtually fitting an eyeglass frame, which comprises:
providing a virtual try-on module running on a server, the virtual try-on module using a processor of the server to:
receive an image of a user wearing an existing eyeglass frame from a user device;
determine eyeglass frame dimension information;
determine pupil diameter and segment height from the image;
determine a set of frames based on a bridge dimension; and
send the determined set of frames to the user device for display on the user device of the user.

2. The method of claim 1, wherein the virtual try-on module provides at least one of image capture, image processing, marker detection, marker adjustment, and measurements based on pixel size and location.

3. The method of claim 1, wherein the determined eyeglass frame dimension information is provided by the user.

4. The method of claim 3, wherein the determined eyeglass frame dimension information is confirmed by the virtual try-on module.

5. The method of claim 3, wherein the eyeglass frame dimension information includes eye size, bridge size, and temple.

6. The method of claim 1, wherein pupil distance is determined by factoring in:
a location of irises in the image;
a location of the bridge in the image; and
a distance between each iris and a middle of a nose bridge in the image.

7. The method of claim 1, wherein pupil distance is determined by factoring in:
pixel size and pixel location; and
a bridge size.

8. The method of claim 1, wherein the segment height is determined based on the location of the irises in the image.

9. The method of claim 1, wherein the pupil distance and the segment height limit an A box dimension and a B box dimension of the set of frames.

10. The method of claim 1, wherein a selected frame of the set of frames is superimposed on the image of the user.

11. A method of virtually fitting an eyeglass frame to a user, which comprises:
providing a virtual try-on module running on a server, the virtual try-on module using a processor of the server to:
receive image and eyeglass frame dimension information;
determine pupil diameter and segment height from the image;
provide a sample set of eyeglass frames, each eyeglass frame in the set of eyeglass frames having lenses with pad printer marks;
determine a subset of the sample set of eyeglass frames by selecting frames where a bottom portion of the pupils of the user in the received image lines up with the bottom portion of the pad printer marks; and
send the determined subset of frames to the user device for display on the user device of the user.

12. The method of claim 11, wherein the virtual try-on module provides at least one of image capture, image processing, marker detection, marker adjustment, and measurements based on pixel size and location.

13. The method of claim 11, wherein a perspective angle is computed and corrected.

14. The method of claim 11, wherein pupil distance is determined by factoring in:
a location of irises in the image;
a location of the bridge in the image; and
a distance between each iris and a middle of a nose bridge in the image.

15. The method of claim 11, wherein pupil distance is determined by factoring in:
pixel size and pixel location; and
a bridge size.

16. The method of claim 11, wherein the segment height is determined based on the location of the irises in the image.

17. The method of claim 11, wherein the pupil distance and the segment height limit an A box dimension and a B box dimension of the set of frames.

18. The method of claim 11, wherein a selected frame of the set of frames is superimposed on the image of the user.

19. The method of claim 11, wherein the pad printer marks are ovals.

20. The method of claim 19, wherein the ovals are 27 mm to 35 mm in width and 12 mm to 22 mm in height.
